(19) United States
(12) Patent Application Publication
(10) Pub. No.: US 2009/0061054 A1
(43) Pub. Date: Mar. 5, 2009

(54) SOUND GENERATING CONTAINER ASSEMBLY AND METHOD FOR STORING CANDY

(76) Inventor: Lawrence T. Jones, Westlake Village, CA (US)

Correspondence Address: SNELL & WILMER LLP (OC), 600 ANTON BOULEVARD, SUITE 1400, COSTA MESA, CA, 92626, US

(21) Appl. No.: 11/847,180

(22) Filed: Aug. 29, 2007

(51) Int. Cl. A23G 3/50

(52) U.S. Cl. 426/138; 426/660

(57) ABSTRACT

A handheld sound generating container assembly for storing candy includes a hollow container housing having an opening and a handle stopper assembly, configured to be removably sealed within the container housing opening. A candy member is mounted on the handle stopper assembly to occupy a substantial volume of the interior of the hollow container housing. A user, by rapidly removing the handle stopper assembly can create an air implosion sound. Consumption of the candy member and reinsertion of the handle stopper assembly will enable the creation of a larger air implosion sound when again rapidly removed from the hollow container housing.

### BACKGROUND OF THE INVENTION

1. Field of the Invention

The present invention is directed to candy confectionary items and more particularly, to a novel toy container assembly for storing hard candy and providing a variable sound.

2. Description of Related Art

The field of providing novelty items for storing candy while providing a play function for the child is a relatively crowded art. Numerous examples of various forms of containers for dispensing candy is well known. Tablets of candy have been dispensed in hand-held dispensers which have included novelty containers that could subsequently perform a function as a toy for the child. For example, a cylindrical candy storage member can unfold a comic strip.

It has also been known to incorporate a sound producing device associated with the sudden release of items like candy. For example, the well known toy piñata is usually struck by a blindfolded child to crack the piñata and release various items including candy. U.S. Pat. No. 4,932,915 discloses a bursting balloon containing for example, small toys, confetti, candy and other like items that can be suddenly released when the balloon is exploded to produce both a sudden sound and the release of the contents.

It is also known to provide high pressure gas charged candy which is hard candy that has pressurized gas entrapped therein so that cracking sounds due to the releasing explosion of the bubbles as the candy is melted in the mouth is produced as shown for example, in U.S. Pat. No. 6,090,430.

Finally, there is a commercial product having a candy member in a casing that requires the user to push the candy member from the casing to expose it for eating purposes.

There is still a need to provide a novelty toy device that permits the consumer to not only enjoy an additional sound effect in a repetitive manner as a novelty toy, but also to consume and store the hard candy in a sanitary environment.

### SUMMARY OF THE INVENTION

The present invention provides a hand-held sound generating container assembly for storing hard candy that includes a hollow container housing having an opening that can be sealed by a handle stopper assembly. The hollow container housing can be provided in various configurations to enhance the toy functions of the device.

The handle stopper assembly includes a sealing member that can be in the form of a piston member that has the capacity of sealing to an upper portion of the hollow container housing. The handle stopper assembly can also include an inverted U-shaped handle extending from the top of the piston member of a configuration to enable a user to easily pull the piston member from the container housing, for example by inserting one or more fingers within the U-shaped handle.

The piston member can further be provided on its bottom surface with a support post of a configuration designed to permit a cantilevered candy configuration to extend from the support post. When the hollow container housing is suddenly removed from the handle assembly, an implosion sound can be created as ambient air rushes in to fill the space previously occupied by the candy member that was cantilevered into the container housing.

In one form of the invention, the hollow container housing, can have a cylindrical transparent configuration and a cylindrical pillar or column of hard candy can be mounted within the container housing to fill substantially the interior volume space of the container housing. The hard candy is sufficiently secured to the piston member's support post to facilitate an accelerated removal of the handle assembly from the container housing and to support it for eating like a lollipop.

The user can subsequently lick and/or suck the candy member and then reinsert the candy member into the container housing for subsequent use.

The combination of the piston member and the container housing can provide a variable implosion sound depending on the volume of candy that is stored therein. That is, a sound which is a function of the speed of removal of the handle assembly with its piston member in contact with an interior surface of the container housing and the actual amount of air captured therein, provides an appropriate sound that will resonate in the empty container housing. When the candy member is first purchased by the user, sound will be provided since a greater void would be left as the stopper assembly is rapidly released from the container housing.

Subsequently, as the candy is enjoyed by the user, a lesser void is provided in the container housing but still can resonate with the candy member having less of a muffling effect. When all of the candy is consumed there is apparently a louder and higher pitched sound as a result of a resonating effect with the empty container housing.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a view of the assembled hollow container housing and handle stopper assembly with a hard candy stick cantilevered and sealed within the hollow container housing;

FIG. 2 is a perspective view disclosing a user pulling the handle assembly to produce the implosion sound;

FIG. 3 is a cross-sectional configuration of the container housing;

FIG. 4 is an elevated view of a handle assembly and candy member;

FIG. 5 is a schematic illustration of the sound generating container assembly;

FIG. 6 discloses the relationship between the piston and the container housing;

FIG. 7 illustrates the sound generating container assembly for the initial sound;

FIG. 8 illustrates the sound generating container assembly for a medium sound; and

FIG. 9 discloses the sound generating container assembly for the loudest sound.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures and components have not been described in detail as not to unnecessarily obscure aspects of the present invention.

The toy candy container assembly 2 is shown in a perspective view in FIG. 1. A container housing number 4 is shown in a cylindrical tubular configuration with a lower closed end and an open entrance. As can be appreciated, alternative configurations included, but not limited to, figurines or caricatures of various characters or objects could also be utilized to enhance novelty effect.

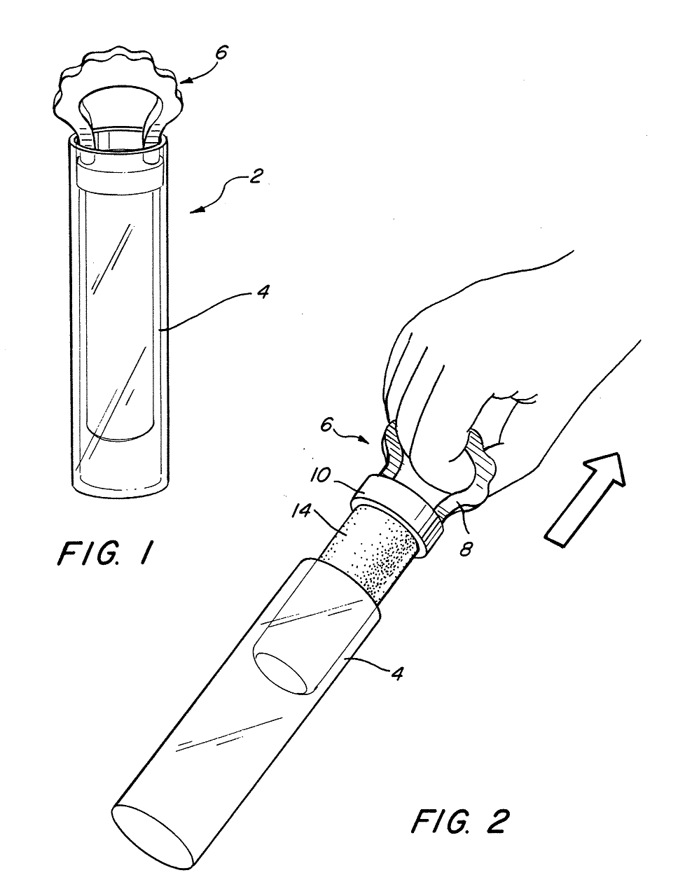

A handle assembly 6 is capable of being sealingly removable from the housing member 4. As can be appreciated a sanitary seal is removably applied between the handle assembly 6 and the housing member 4 for the initial retail sale. The user, after removal of the sanitary seal (not shown), is then capable of grasping the handle assembly 6 and rapidly pulling it free from the housing member 4 as shown in FIG. 2. The speed of removal also has an effect on the level of sound and rapidly in the range of one hundreds of a second is a preferred level of sound.

A sudden release of the handle assembly 6 will not only expose an elongated cylindrical hard candy stick 14, but will also create a surprising popping or implosion sound. The handle assembly 6 is capable of taking numerous types of configurations and is basically designed for a child's hand. The handle member 8 shown in FIGS. 2 and 4 has an inverted U-shape or horseshoe shape attached to the piston member 10. The opening in the handle member 8 permits one or more fingers of the user to grasp the handle with a curvilinear outer configuration compatible with the palm of the hand of the user.

The piston member 10 is formed of a plastic such as polypropylene and can be molded integrally with the handle member 8 of any desired configuration. At the bottom surface of the piston member is a centrally located support post 12 which can also be molded during the formation of the handle assembly 6.

A hard candy of a type generally known in the confectionary industry for lollipops, can be appropriately molded into different configurations and adhered and supported on the support post 12 so that it is cantilevered from the piston member 10.

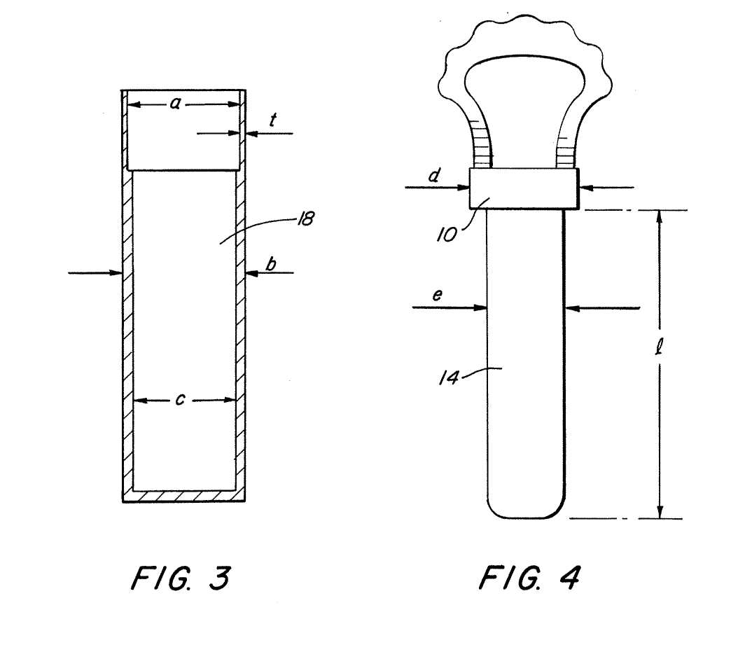

Referring to FIG. 3, the internal diameter, “a,” of the open upper surface or entrance area of the housing member is 21.17 mm with a wall thickness, “t,” of 1.7 mm. The outer diameter, “b,” of the housing member 4 is 23.7 mm. The internal diameter, “c,” of the candy storage chamber 18 is 19.7 mm with a tube wall thickness, “T,” of 2 mm. As a result, an annular interior ledge 16 serves a function as a stop position for the lower bottom surface of the piston member 10.

Referring to FIG. 4, the piston member 10 has a diameter, “d,” of 21.04 mm while the hard candy, “e,” has a 15 mm diameter. The length, “l,” of the hard candy is 86.5 mm.

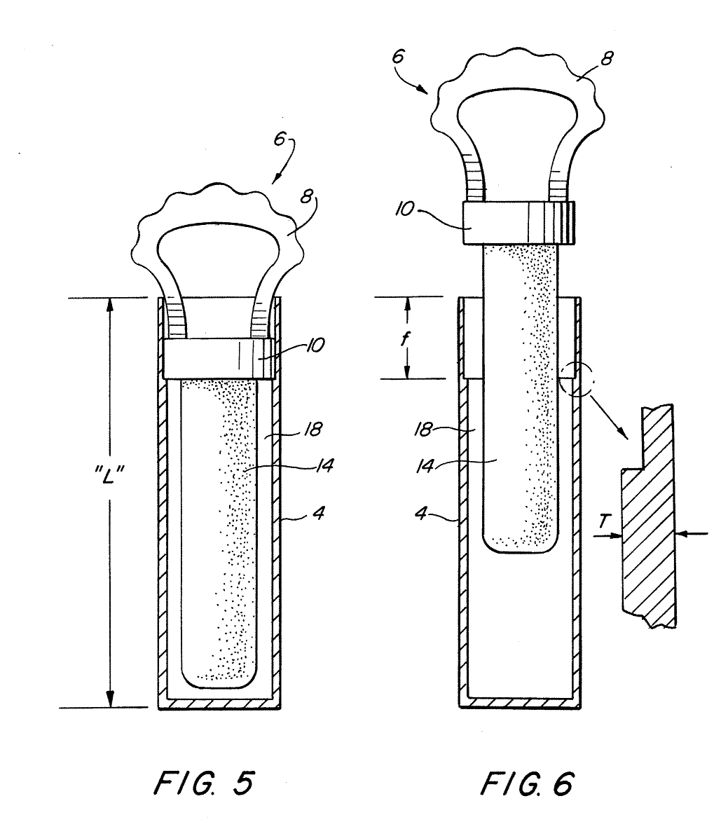

When the hard candy is inserted within the candy storage chamber 18, as shown for example in FIG. 5, the piston member 10 fits snugly against the housing member entrance portion and the entire length, “L,” of the toy candy container assembly is 107 mm. The length, “f” of the entrance portion as shown in FIG. 6 is 14 mm.

FIG. 6 also shows a schematic exploded cross sectional view of the container housing showing the annular ledge 16 which enables the bottom surface of the piston member 10 to rest on the ledge 16 and form with the adjacent cylinder wall, a relatively tight air fit.

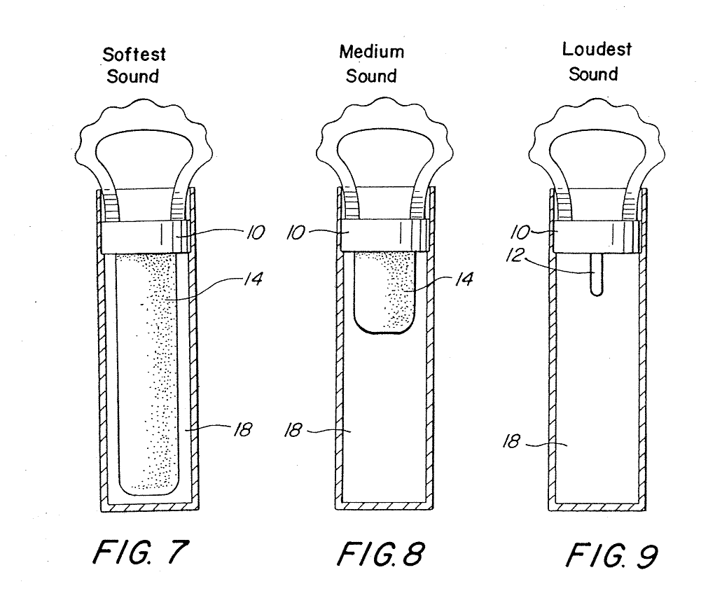

FIG. 7 is a schematic cross sectional view disclosing the toy candy container assembly 2 as initially provided to the user. At this point the hard candy stick 14 occupies approximately two thirds of the volume of the candy storage chamber 18. A rapid release of the handle assembly 6, as shown in FIG. 2, will not only expose the hard candy stick for consumption but will further produce a surprising and pleasant popping sound for the user.

FIG. 8 discloses a hard candy stick 14 after it has been substantially consumed and restored in the container housing member 4 for storage purposes. Again, the user can produce a pleasant popping sound by a rapid removal of the handle assembly 6 with a release of the piston member 10 from the housing member 4. The resulting implosion sound is somewhat louder than the initial sound and it is possible that the hard candy stick forms somewhat of a baffle for modifying the potential sound of the implosion of air. This is only an assumption and a person can enjoy a pleasant popping sound by replicating the design shown in our present application regardless of the theory on sound.

Finally, FIG. 9 discloses the toy candy container assembly 2 when the hard candy stick 14 has been consumed and the support post 12 is exposed. As can be appreciated, the candy storage chamber 18 will accommodate the maximum trapped air and again a rapid release of the handle assembly 6 and the container housing member 4 will produce the largest popping sound at apparently a higher frequency. Again, it is assumed that the resonating sound generating capacity of the candy storage chamber 18 plays a part in producing this sound.

As can be readily appreciated, the user not only has the enjoyment of the hard candy stick with the capacity of partially eating the hard candy stick 14 and then storing it for future consumption in a relatively clean environment but further has the capacity of still providing a surprising popping sound even after the hard candy stick 14 has been consumed, so that a novelty sound producing toy is available for further enjoyment of the user.

The method of using the sound generating container assembly of the present invention involves removing the handle stopper assembly 6 from the hollow container housing member 4 with a rapid movement that is within one hundreds of a second to generate a first implosion sound. The first implosion sound is not the loudest sound that can be produced when used as a toy novelty item since it is believed that the cantilevered candy stick member provides a baffling action in muffling or moderating the sound and pitch of the implosion.

The user can then partially or totally consume the cantilevered stick member 14 and can reinsert the handle stopper assembly 6 into the hollow container housing 4 in a sealing manner. In this regard the piston member 10 is appropriately mounted on the annular ledge 16 of the container housing member 4. Thus, a sanitary storage, or at least a protective storage, of any unconsumed portion of the cantilevered candy stick member is provided.

The user can then again rapidly remove the handle stopper assembly 6 at substantially the same rate of removal as the occasion of the first implosion sound to thereby produce a second implosion sound that should be louder than the first implosion sound as a function of the removal of the portion of the cantilevered candy stick member 14.

When the candy stick member 14 is completely consumed, the toy candy container assembly can then function as a novelty toy and can produce the loudest sound for the same rate of removal of the handle stopper assembly 6 from the container housing member 4.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A handheld sound generating container assembly for storing candy, comprising:
a hollow container housing having an opening;
a handle stopper assembly having a sealing portion configured to removably seal within the container housing opening; and
a candy member mounted on the handle stopper assembly and having a configuration to occupy a substantial volume of an interior of the hollow container housing whereby a rapidly removal of the handle stopper assembly from a sealed position in the container housing produces an air implosion sound and releases the candy member for consumption by the user.

2. The container assembly of claim 1 wherein the handle stopper assembly includes a piston member that contacts the interior of the container housing to form the sealing portion.

3. The container assembly of claim 2 wherein the container housing has an annular flange to provide a stop position for the piston member.

4. The container assembly of claim 1 wherein the handle stopper assembly includes an inverted U-shaped handle of a configuration to receive at least one finger of a user to enable a pulling of the sealing portion from the container housing to provide an implosion sound.

5. The container assembly of claim 1 wherein the handle assembly includes a piston member as the sealing portion with a support post extending from a bottom of the piston member to anchor the candy member and an inverted U-shaped handle extending from a top of the piston member of a configuration to enable a user to pull the piston member from the container housing to provide an implosion sound.

6. The container assembly of claim 5 wherein the handle stopper assembly is integrally formed of moldable plastic.

7. The container assembly of claim 6 wherein the plastic is polypropylene.

8. The container assembly of claim 1 wherein the candy member is a cylinder of hard candy cantilevered from the handle stopper assembly.

9. A method of providing a variable sound from a handheld sound generating container assembly that stores an eatable candy stick member comprising the steps of:
providing a handle stopper assembly with a cantilevered candy stick member;
providing a hollow container housing having an opening of a configuration to seal with the handle stopper assembly;
mounting the handle stopper assembly in a sealing manner within the hollow container housing;
rapidly removing the handle stopper assembly from the hollow container housing to generate a first implosion sound;
remove partially and/or all of the cantilevered candy stick member;
re-inserting the handle stopper assembly in a sealing manner with the hollow container housing with the partially and/or all of the consumed cantilevered candy stick; and
rapidly removing the handle stopper assembly at substantially the same rate of removal to produce a second implosion sound that is louder than the first implosion sound as a function of the removal of partially and/or all of the cantilevered candy stick member.

10. The method of claim 9 further including removal of all of the candy stick member to provide the loudest sound for the same rate of removal of the handle stopper assembly.
